(19) United States
(12) Patent Application Publication
(10) Pub. No.: US 2022/0287301 A1
(43) Pub. Date: Sep. 15, 2022

(54) POLYMERS FOR SPRAY DRIFT CONTROL OF PESTICIDE SPRAY

(71) Applicant: BASF SE, Ludwigshafen am Rhein (DE)

(72) Inventors: Timothy H. Anderson, Cincinnati, OH (US); Dean A. Oester, Cincinnati, OH (US)

(21) Appl. No.: 17/639,374

(22) PCT Filed: Aug. 26, 2020
(86) PCT No.: PCT/EP2020/073793

§ 371 Date: Mar. 1, 2022

Related U.S. Application Data
(60) Provisional application No. 62/895,170, filed on Sep. 3, 2019.

(30) Foreign Application Priority Data
Nov. 11, 2019 (EP) 19208222.0

(51) Int. Cl. A01N 25/30; A01N 25/06

(52) U.S. Cl. CPC A01N 25/30; A01N 25/06

(57) ABSTRACT

Described herein is an agricultural composition including at least one cationic polymer and an agriculturally active agent where the cationic polymer has at least one quaternary nitrogen atom. The agricultural composition is used in agricultural spray operations and demonstrates effective reduction of driftable droplets.

### FIELD OF THE INVENTION

The present invention relates to an agricultural composition comprising a cationic polymer and an agriculturally active compound where the cationic polymer has at least one quaternary nitrogen atom. Specifically, the present invention relates to an agricultural composition used in agricultural spray operations and demonstrates effective control of spray drift.

### BACKGROUND OF THE INVENTION

Use of pesticides is essential in farming and agricultural industries. In these industries, the pesticides reduce the presence of harmful organisms and plants (such as weeds) that decrease crop yields and crop quality. When pesticides are applied, it is aimed at a specific target, and expected to reach a specific target, such as a plant. When a pesticide travels to areas where it is not needed or wanted, (i.e., when the pesticide “drifts”), unwanted consequences may result. Almost every pesticide, upon spray application, produces some amount of drift off of the target area. Drift is affected by factors such as the formulation of the pesticide, the amount of the pesticide sprayed, the application method, the weather, and the auxiliaries which are present in the spray solution. More specifically, drift is the movement of the pesticide through the air away from the intended target. The drift can be in the form of water or liquid droplets.

Spray drift typically describes drift that occurs during or shortly after spraying of the pesticide on the target. Application is, for example, accomplished using ground spraying equipment or via aerial spraying. Spray drift often occurs when wind blows the pesticide off the intended target. The prior art discloses the use of non-ionic polymers or anionic polymers in the formulation for improved spray drift control.

CN 108887267 A discloses an anti-drift composition comprising 1-20% polysaccharide, 5-40% polyquaternium, 10-40% silicone adjuvant and solvent.

CN 109452271 A discloses a rainwater-resistant scouring agrochemical auxiliary composition and an application thereof.

WO 2007/031438 A2 discloses a pesticide or herbicide composition in either a sprayable formulation form or an aqueous concentrate comprising at least one pesticide or a herbicide active and a spray drift control agent comprising at least one water soluble cationic polymer that has been formed from ethylenically unsaturated monomers and at least cationic surfactant.

PL 224026 B1 relates to novel monofunctional poly(diallyldimethylammonium) herbicidal ionic liquids and to a process for their preparation and use as a plant protection agent.

Accordingly, there is still a need for improvement in the control of the spray drift.

### SUMMARY OF THE INVENTION

It was surprisingly found that the present composition, comprising at least one cationic polymer containing at least one quaternary nitrogen atom provided excellent spray drift control and shear stability.

In an aspect of the present invention, the composition for spray drift control comprises,
i. at least one cationic polymer containing at least one quaternary nitrogen atom; and
ii. at least one agriculturally active compound.

In another aspect of the present invention, a method for reducing spray drift, the method comprising spraying the aqueous composition comprising at least one cationic polymer containing one quaternary nitrogen atom and at least one agriculturally active compound onto a tract of land either prior to planting an agricultural crop or pre- or post-harvest of an agricultural crop.

In a further aspect of the present invention, the use of the composition comprising at least one cationic polymer containing one quaternary nitrogen atom and at least one agriculturally active compound for controlling spray drift.

In yet another aspect of the present invention, a kit of parts as separate components wherein the first component is at least one cationic polymer containing at least one quaternary nitrogen atom for a combined use with a second component which is at least one agriculturally active compound.

### DETAILED DESCRIPTION OF THE INVENTION

Before the present compositions and formulations of the invention are described, it is to be understood that this invention is not limited to compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range from 1 to 10 implies that both 1 and 10 are included in the range. For the avoidance of doubt, applicant shall be entitled to any equivalents according to applicable law.

As defined herein “spray drift” is the movement of the pesticide through the air away from the intended target. The drift can be in the form of water or liquid droplets.

As defined herein “agriculturally active compounds” are selected from pesticides, safeners and/or growth regulators. The pesticides are further defined as fungicides, insecticides, nematicides, herbicides.

The present invention relates to a composition for spray drift control comprising at least one cationic polymer containing at least one quaternary nitrogen atom; and at least one agriculturally active compound

### Cationic Polymer

In an embodiment of the present invention, the cationic polymer containing at least one quaternary nitrogen atom is generally a reaction product of at least one ethylenically unsaturated, quaternizable or quaternized monomer; and optionally at least one ethylenically unsaturated, non-quaternizable monomer.

In another embodiment of the present invention, the ethylenically unsaturated, quaternizable or quaternized monomer are selected from N-vinyl imidazole, diallylamines, amino alkyl acrylates or methacrylates, N,N,N-trialkyl aminoalkyl acrylates, N,N,N-trialkyl aminoalkyl methacrylate.

In an embodiment of the present invention, the quaternary N-vinyl imidazoles of general formula (I) are

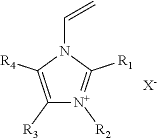

Where R₁, R₃, R₄, independently of one another, are hydrogen, C₁-C₄ linear or branched alkyl, C₁-C₄-hydroxyalkyl or phenyl; and R₂ is C₁-C₄-linear or branched alkyl, C₁-C₄-hydroxyalkyl or phenyl; and

and X⁻ is an anion selected from acetate, methylsulfate or halide such as, chloride or bromide.

In an embodiment of the present invention, the quaternary N-vinyl imidazoles is selected from 3-methyl vinyl-imidazolium methyl sulfate, 3-methyl vinyl-imidazolium chloride

In an embodiment of the present invention, the diallylamines are of the general formula (II)

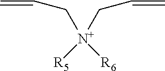

Where where R₅ and R₆ in each case and independently of one another may be C₁- to C₂₄-linear or branched alkyl, and X⁻ is an anion selected from acetate, methylsulfate or halide such as, chloride or bromide.

In an embodiment of the present invention, the diallylamines is N,N-diallyl N,N-dimethyl ammonium chloride.

In an embodiment of the present invention the aminoalkyl acrylate and methacrylate are of the general formula (III)

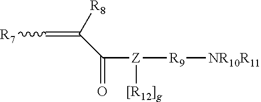

Where R₇ and R₈ are independently of one another, are chosen from the group consisting of hydrogen, C₁-C₈ linear or branched alkyl, methoxy, ethoxy, 2-hydroxyethoxy, 2-methoxyethoxy and 2-ethoxyethyl.

R₉ is alkylene or hydroxyalkylene having 1 to 24 carbon atoms, optionally substituted by alkyl, preferably C₂H₄, C₃H₆, C₄H₈, CH₂—CH(OH)—CH₂

R₁₀ and R₁₁ are in each case and independently of one another chosen from the group consisting of hydrogen, C₁-C₄₀ linear or branched alkyl, formyl, C₁-C₁₀ linear or branched acyl, N,N-dimethylaminoethyl, 2-hydroxyethyl, 2-methoxyethyl, 2-ethoxyethyl, hydroxypropyl, methoxypropyl, ethoxypropyl or benzyl

R₁₂ is hydrogen or methyl

g is 0 or 1

Z is nitrogen when g=1 or oxygen when g=0.

In an embodiment of the present invention, the aminoalkyl acrylate and methacrylate are selected from dimethylaminoethyl methacrylate, N,N-dimethylaminoethyl methacrylate, N-[3-(dimethylamino)propyl]methacrylamide, N-methylaminoethyl methacrylate, N-[3-(methylamino)propyl]methacrylamide, aminoethyl methacrylate and N-[3-aminopropyl]methacrylamide.

In an embodiment of the present invention, the N,N,N-trialkyl aminoalkyl acrylates, N,N,N-trialkyl aminoalkyl methacrylate are of the general formula (IV)

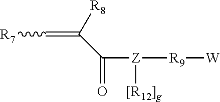

Where R₇, R₈R₉, R₁₂ and Z have the same meaning as above.

W is —N(R₁₃)₃/X⁻ where R₁₃ may be chosen to be identical or different from the group consisting of C₁-C₄₀ linear or branched alkyl radicals, formyl, C₁-C₁₀ linear or branched acyl, N,N-dimethylaminoethyl, 2-hydroxyethyl, 2-methoxyethyl, 2-ethoxyethyl, hydroxypropyl, methoxypropyl, ethoxypropyl or benzyl, preferably methyl, ethyl and n-propyl,

X⁻ is an anion selected from acetate, methylsulfate or halide such as, chloride or bromide.

In an embodiment of the present invention, the N,N,N-trialkyl aminoalkyl acrylates, N,N,N-trialkyl aminoalkyl methacrylate are selected from N,N,N-trimethylaminomethyl (meth)acrylate, N,N,N-triethylaminomethyl (meth)acrylate, N,N,N-trimethylaminoethyl (meth)acrylate, N,N,N-triethylaminoethyl (meth)acrylate, N,N,N-trimethylaminobutyl (meth)acrylate, N,N,N-triethylaminobutyl (meth)acrylate, N,N,N-trimethylaminohexyl (meth)acrylate, N,N,N-trimethylaminooctyl (meth)acrylate, N,N,N-trimethylaminododecyl (meth)acrylate (meth) acryloyloxyhydroxypropyl trimethylammonium chloride and (meth)acryloyloxyhydroxypropyltriethylammonium chloride.

In yet another embodiment of the present invention, the ethylenically unsaturated, quaternizable or quaternized monomer are selected from N-vinyl imidazolium chloride, 3-methyl vinyl-imidazolium methyl sulfate, 3-methyl vinyl-imidazolium chloride, N,N-diallyl N,N-dimethyl ammonium chloride, dimethylaminoethyl methacrylate, 2-methylacryloxyethyltrimethyl ammonium chloride

In yet another embodiment of the present invention, the ethylenically unsaturated, non-quaternizable, monomer is selected from N-vinyl lactams, ethylenically unsaturated amides.

In another embodiment of the present invention, the ethylenically unsaturated, non-quaternizable, monomer is selected from N-vinyl pyrrolidone, N-vinyl piperidone and N-vinyl caprolactam, acrylamide and methacrylamide.

In an embodiment of the present invention, the at least one cationic polymer is obtained by polymerization reactions known in the art. The polymerization can be carried out, for example, as solution polymerization, bulk polymerization, emulsion polymerization, inverse emulsion polymerization, suspension polymerization, inverse suspension polymerization or precipitation polymerization without the methods which can be used being limited thereto.

In an embodiment of the present invention, the at least one cationic polymer containing at least one quaternary nitrogen atom is a reaction product of N-vinyl pyrrolidone and dimethyl aminoethyl methacrylate

In another embodiment of the present invention the at least one cationic polymer containing at least one quaternary nitrogen atom is a reaction product of N,N-diallyl N,N-dimethyl ammonium chloride and acrylamide.

In another embodiment of the present invention, the at least one cationic polymer containing at least one quaternary nitrogen atom is a reaction product of N-vinyl pyrrolidone and N-vinyl imidazolium chloride.

In another embodiment of the present invention, the at least one cationic polymer containing at least one quaternary nitrogen atom is a reaction product of N-vinyl caprolactam, N-vinyl pyrrolidone and 3-methyl N-vinyl imidazolium methylsulfate.

In another embodiment of the present invention, the at least one cationic polymer containing at least one quaternary nitrogen atom is a reaction product of 2-methacryloxyethyl trimethyl ammonium chloride.

In an embodiment of the present invention, cationic polymer has a weight average molecular weight (Mw) of from 100,000 to 1,000,000, from 50,000 to 900,000, from 50,000 to 700,000, or from 50,000 to 500,000 g/mol.

In other embodiment, the cationic polymer has a charge density in the range of 0.5 to 10 meq/g, determined at a pH of 7.

The charge density of the cationic polymer is defined as the amount of cationic charge per gram of the given polymer. The charge density is measured using conductometric analysis at the pH specified. In the present invention, the charge density of the cationic polymer is measured at a pH of 7.

### Agriculturally Active Compound

In an embodiment of the present invention, agriculturally active compound is selected from pesticides, safeners and/or growth regulators. The pesticides are further defined as fungicides, insecticides, nematicides, herbicides. Mixtures of pesticides of two or more of the abovementioned classes may also be used.

The skilled person is familiar with such pesticides, which can be found, for example, in the Pesticide Manual, 15th Ed. (2009), The British Crop Protection Council, London. The following list give examples of pesticides which may be used as pesticide.

In an embodiment of the present invention, the fungicides are

### A) Respiration Inhibitors

Inhibitors of complex III at Qo site (e.g. strobilurins): azoxystrobin, coumethoxystrobin, cou moxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide, pyribencarb, triclopyricarb/chlorodincarb, famoxadone, fenamidone;

Inhibitors of complex III at Qi site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl] 2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl] 2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl] 2-methylpropanoate;

Inhibitors of complex II (e.g. carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide;

Other respiration inhibitors (e.g. complex I, uncouplers): diflumetorim, (5,8-difluoroquinazolin-4-yl)-{2-[2-fluoro-4-(4-trifluoromethylpyridin-2-yloxy)-phenyl]-ethyl}-amine; nitrophenyl derivates: binapacryl, dinobuton, dinocap, fluazinam; ferimzone; organometal compounds: fentinsalts, such as fentin-acetate, fentin chloride or fentin hydroxide; ametoctradin; and silthiofam;

### B) Sterol Biosynthesis Inhibitors (SBI Fungicides)

C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizol; pyrimidines, pyridines and piperazines: fenarimol, nuarimol, pyrifenox, triforine;

Delta14-reductase inhibitors: aldimorph, dodemorph, dodemorph-acetate, fenpropimorph, tridemorph, fenpropidin, piperalin, spiroxamine;

Inhibitors of 3-keto reductase: fenhexamid;

### C) Nucleic Acid Synthesis Inhibitors

Phenylamides or acyl amino acid fungicides: benalaxyl, benalaxyl-M, kiralaxyl, metalaxyl, metalaxyl-M (mefenoxam), ofurace, oxadixyl;

Others: hymexazole, octhilinone, oxolinic acid, bupirimate, 5-fluorocytosine, 5-fluoro-2-(ptolylmethoxy) pyrimidin-4-amine, 5-fluoro-2-(4-fluorophenylmethoxy)pyrimidin-4-amine;

### D) Inhibitors of Cell Division and Cytoskeleton

Tubulin inhibitors, such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine

Other cell division inhibitors: diethofencarb, ethaboxam, pencycuron, fluopicolide, zoxamide, metrafenone, pyriofenone;

### E) Inhibitors of Amino Acid and Protein Synthesis

Methionine synthesis inhibitors (anilino-pyrimidines): cyprodinil, mepanipyrim, pyrimethanil;

Protein synthesis inhibitors: blasticidin-S, kasugamycin, kasugamycin hydrochloride-hydrate, mildiomycin, streptomycin, oxytetracyclin, polyoxine, validamycin A;

### F) Signal Transduction Inhibitors

MAP/histidine kinase inhibitors: fluoroimid, iprodione, procymidone, vinclozolin, fenpiclonil, fludioxonil;

G protein inhibitors: quinoxyfen;

### G) Lipid and Membrane Synthesis Inhibitors

Phospholipid biosynthesis inhibitors: edifenphos, iprobenfos, pyrazophos, isoprothiolane;

Lipid peroxidation: dicloran, quintozene, tecnazene, tolclofos-methyl, biphenyl, chloroneb, etridiazole;

Phospholipid biosynthesis and cell wall deposition: dimethomorph, flumorph, mandipropamid, pyrimorph, benthiavalicarb, iprovalicarb, valifenalate and N-(1-(1-(4-cyano-phenyl)-ethanesulfonyl)-but-2-yl) carbamic acid-(4-fluorophenyl) ester;

Compounds affecting cell membrane permeability and fatty acides: propamocarb, propamocarb-hydrochlorid

H) Inhibitors with Multi Site Action

Inorganic active substances: Bordeaux mixture, copper acetate, copper hydroxide, copperoxychloride, basic copper sulfate, sulfur;

Thio- and dithiocarbamates: ferbam, mancozeb, maneb, metam, metiram, propineb, thiram, zineb, ziram;

Organochlorine compounds (e.g. phthalimides, sulfamides, chloronitriles): anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-Nethyl-4-methyl-benzenesulfonamide;

Guanidines and others: guanidine, dodine, dodine free base, guazatine, guazatine-acetate, iminoctadine, iminoctadine-triacetate, iminoctadine-tris(albesilate), dithianon;

### I) Cell Wall Synthesis Inhibitors

inhibitors of glucan synthesis: validamycin, polyoxin B; melanin synthesis inhibitors: pyroquilon, tricyclazole, carpropamid, dicyclomet, fenoxanil;

### J) Plant Defence Inducers

Acibenzolar-S-methyl, probenazole, isotianil, tiadinil, prohexadione-calcium; phosphonates: fosetyl, fosetyl-aluminum, phosphorous acid and its salts;

### K) Unknown Mode of Action

Bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-Nmethyl formamidine, N′-(5-difluoromethyl-2-methyl-4-(3-trimethylsilanyl-propoxy)-phenyl)-Nethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, methoxy-acetic acid 6-tert-butyl-8-fluoro-2,3-dimethyl-quinolin-4-yl ester, N-Methyl-2-{1-[(5-methyl-3-trifluoro methyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-methylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl) cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide;

### L) Antifungal Biocontrol Agents, Plant Bioactivators:

Ampelomyces quisqualis (e.g. AQ 10® from Intrachem Bio GmbH & Co. KG, Germany), Aspergillus flavus (e.g. AFLAGUARD® from Syngenta, CH), Aureobasidium pullulans (e.g. BOTECTOR® from bio-ferm GmbH, Germany), Bacillus pumilus (e.g. NRRL Accession No. B-30087 in SONATA® and BALLAD® Plus from AgraQuest Inc., USA), Bacillus subtilis (e.g. isolate NRRL-Nr. B-21661 in RHAPSODY®, SERENADE® MAX and SERENADE® ASO from AgraQuest Inc., USA), Bacillus subtilis var. amyloliquefaciens FZB24 (e.g. TAEGRO® from Novozyme Biologicals, Inc., USA), Candida oleophila I-82 (e.g. ASPIRE® from Ecogen Inc., USA), Candida saitoana (e.g. BIOCURE® (in mixture with lysozyme) and BIOCOAT® from Micro Flo Company, USA (BASF SE) and Arysta), Chitosan (e.g. ARMOUR-ZEN from BotriZen Ltd., NZ), Clonostachys rosea f. catenulata, also named Gliocladium catenulatum (e.g. isolate J1446:PRESTOP® from Verdera, Finland), Coniothyrium minitans (e.g. CONTANS® from Prophyta, Germany), Cryphonectria parasitica (e.g. Endothia parasitica from CNICM, France), Cryptococcusalbidus (e.g. YIELD PLUS® from Anchor Bio-Technologies, South Africa), Fusariumoxysporum (e.g. BIOFOX® from S.I.A.P.A., Italy, FUSACLEAN® from Natural Plant Protection, France), Metschnikowia fructicola (e.g. SHEMER® from Agrogreen, Israel), Microdochium dimerum (e.g. ANTIBOT® from Agrauxine, France), Phlebiopsis gigantea (e.g. ROTSOP® from Verdera, Finland), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis (e.g. REGALIA® from Marrone BioInnovations, USA), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. harzianum T-22 (e.g. PLANTSHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000® from Mycontrol Ltd., Israel and Makhteshim Ltd., Israel), T. harzianum and T. viride (e.g. TRICHOPEL from Agrimm Technologies Ltd, NZ), T. harzianum ICC012 and T. viride ICC080 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (e.g. SOILGARD® from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy), Ulocladium oudemansii HRU3 (e.g. BOTRY-ZEN® from Botry-Zen Ltd, NZ);

In an embodiment of the present invention, the growth regulators are selected from Abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadionecalcium), prohydrojasmon, thidiazuron, triapenthenol, tributyl phosphorotrithioate, 2,3,5-tri-iodobenzoic acid, trinexapac-ethyl and uniconazole;

In an embodiment of the present invention the herbicides are selected from

Acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;

Amino acid derivatives: bilanafos, glyphosate, glufosinate, sulfosate;

Aryloxyphenoxypropionates: clodinafop, cyhalofop-butyl, fenoxaprop, fluazifop, haloxyfop, metamifop, propaquizafop, quizalofop, quizalofop-P-tefuryl;

Bipyridyls: diquat, paraquat;

(thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;

Cyclohexanediones: butroxydim, clethodim, cycloxydim, profoxydim, sethoxydim, tepraloxydim, tralkoxydim;

Dinitroanilines: benfluralin, ethalfluralin, oryzalin, pendimethalin, prodiamine, trifluralin;

Diphenyl ethers: acifluorfen, aclonifen, bifenox, diclofop, ethoxyfen, fomesafen, lactofen, oxyfluorfen;

Hydroxybenzonitriles: bomoxynil, dichlobenil, ioxynil;

Imidazolinones: imazamethabenz, imazamox, imazapic, imazapyr, imazaquin, imazethapyr;

Phenoxy acetic acids: clomeprop, 2,4-dichlorophenoxyacetic acid (2,4-D), 2,4-DB, dichlorprop, MCPA, MCPA-thioethyl, MCPB, Mecoprop;

Pyrazines: chloridazon, flufenpyr-ethyl, fluthiacet, norflurazon, pyridate;

Pyridines: aminopyralid, clopyralid, diflufenican, dithiopyr, fluridone, fluroxypyr, picloram, picolinafen, thiazopyr, triclopyr (2-[(3,5,6-trichloro-2-pyridinyl)oxy] acetic acid, butoxyethyl ester);

Sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;

Triazines: ametryn, atrazine, cyanazine, dimethametryn, ethiozin, hexazinone, metamitron, metribuzin, prometryn, simazine, terbuthylazine, terbutryn, triaziflam;

Ureas: chlorotoluron, daimuron, diuron, fluometuron, isoproturon, linuron, methabenzthiazuron, tebuthiuron;

Other acetolactate synthase inhibitors: bispyribac-sodium, cloransulam-methyl, diclosulam, florasulam, flucarbazone, flumetsulam, metosulam, ortho-sulfamuron, penoxsulam, propoxy carbazone, pyribambenz-propyl, pyribenzoxim, pyriftalid, pyriminobac-methyl, pyrimisulfan, pyrithiobac, pyroxasulfone, pyroxsulam;

Others: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methyl arsenic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-5 3,6-dihydro-2Hpyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methylphenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.

In an embodiment of the present invention, the insecticides are selected from

Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphosmethyl, profenofos, prothiofos, sulprophos, tetrachlorvinphos, terbufos, triazophos, trichlorfon;

Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

Pyrethroids: allethrin, bifenthrin, cyfluthrin, cyhalothrin, cyphenothrin, cypermethrin, alphacypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, py rethrin I and II, resmethrin, silafluofen, tau-fluvalinate, tefluthrin, tetramethrin, tralomethrin, transfluthrin, profluthrin, dimefluthrin;

Insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;

Nicotinic receptor agonists/antagonists compounds: clothianidin, dinotefuran, flupyradifurone, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane; -GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioicacid amide;

Macrocyclic lactone insecticides: abamectin, emamectin, milbemectin, lepimectin, spinosad, spinetoram;

Mitochondrial electron transport inhibitor (METI) I acaricides: fenazaquin, pyridaben, tebufenpyrad, tolfenpyrad, flufenerim;

METI II and III compounds: acequinocyl, fluacyprim, hydramethylnon;

Uncouplers: chlorfenapyr;

Oxidative phosphorylation inhibitors: cyhexatin, diafenthiuron, fenbutatin oxide, propargite;

Moulting disruptor compounds: cryomazine;

Mixed function oxidase inhibitors: piperonyl butoxide;

Sodium channel blockers: indoxacarb, metaflumizone;

Others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, dinotefuran, and pyrifluquinazon.

In an embodiment of the present invention, the composition is in the form of dusting powders, wettable powders, granules, emulsifiable or suspension concentrates, aqueous compositions and microencapsulated granules.

In an embodiment of the present invention, the composition is an aqueous composition comprising water and the composition selected from dusting powders, wettable powders, granules, emulsifiable or suspension concentrates, aqueous compositions and microencapsulated granules

In an embodiment of the present invention the composition is an aqueous composition comprising the at least one cationic polymer and at least one agriculturally active compound.

In an embodiment of the present invention the composition is an aqueous composition comprising the at least one cationic polymer and at least one pesticide.

In an embodiment of the present invention the composition is an aqueous composition comprising the at least one cationic polymer containing at least one quaternary nitrogen atom is selected from the reaction product of N-vinyl pyrrolidone and dimethyl aminoethyl methacrylate, N,N-diallyl N,N-dimethyl ammonium chloride and acrylamide, N-vinyl pyrrolidone and N-vinyl imidazolium chloride, N-vinyl caprolactam, N-vinyl pyrrolidone and 3-methyl N-vinyl imidazolium methylsulfate, 2-methacryloxyethyl trimethyl ammonium chloride and at least one pesticide

In an embodiment of the present invention the composition is an aqueous composition comprising the at least one cationic polymer containing at least one quaternary nitrogen atom is selected from the reaction product of N-vinyl pyrrolidone and dimethyl aminoethyl methacrylate, N,N-diallyl N,N-dimethyl ammonium chloride and acrylamide, N-vinyl pyrrolidone and N-vinyl imidazolium chloride, N-vinyl caprolactam, N-vinyl pyrrolidone and 3-methyl N-vinyl imidazolium methylsulfate, 2-methacryloxyethyl trimethyl ammonium chloride and at least one fungicide.

In an embodiment of the present invention the composition is an aqueous composition comprising the at least one cationic polymer containing at least one quaternary nitrogen atom is selected from the reaction product of N-vinyl pyrrolidone and dimethyl aminoethyl methacrylate, N,N-diallyl N,N-dimethyl ammonium chloride and acrylamide, N-vinyl pyrrolidone and N-vinyl imidazolium chloride, N-vinyl caprolactam, N-vinyl pyrrolidone and 3-methyl N-vinyl imidazolium methylsulfate, 2-methacryloxyethyl trimethyl ammonium chloride and at least one insecticide.

In an embodiment of the present invention, the composition is an aqueous composition comprising the at least one cationic polymer which is the reaction product of N,N-diallyl N,N-dimethyl ammonium chloride and acrylamide and a herbicide.

In an embodiment of the present invention, the composition is an aqueous composition comprising the at least one cationic polymer which is the reaction product of N,N-diallyl N,N-dimethyl ammonium chloride and acrylamide and a fungicide.

In an embodiment of the present invention, the composition is an aqueous composition comprising the at least one cationic polymer which is the reaction product of N,N-diallyl N,N-dimethyl ammonium chloride and acrylamide and glyphosate.

In an embodiment of the present invention, the composition is an aqueous composition comprising the at least one cationic polymer which is the reaction product of N,N-diallyl N,N-dimethyl ammonium chloride and acrylamide and pyroclostrobin.

In an embodiment of the present invention, the composition is an aqueous composition comprising the at least one cationic polymer which is the reaction product of N,N-diallyl N,N-dimethyl ammonium chloride and acrylamide and triclopyr.

In an embodiment of the present invention the composition further comprises at least one adjuvant.

In yet another embodiment of the present invention, the at least one cationic polymer in the range of from 0.003 vol. % to 1 vol. %, in another embodiment, 0.003 vol. % to 0.9 vol. %, in further embodiment 0.003 vol. % to 0.8 vol. % in yet another embodiment 0.003 vol. % to 0.7 vol. %, in a further embodiment 0.003 vol. % to 0.6 vol. %, in another embodiment 0.003 vol. % to 0.5 vol. %, in another embodiment 0.003 vol. % to 0.4 vol. %, in further embodiment 0.003 vol. % to 0.3 vol. %, in further embodiment 0.003 vol. % to 0.2 vol. %, in further embodiment 0.003 vol. % to 0.1 vol. %.

In yet another embodiment of the present invention, the at least one agriculturally active compound is in the range of from 0.25 wt. % to 5 wt. %, in another embodiment from 0.25 wt. % to 4.5 wt. %, in another embodiment, 0.25 wt. % to 4 wt. %, in further embodiment 0.25 wt. % to 3.5 wt. %, in yet another embodiment 0.25 wt. % to 3 wt. %, in a further embodiment 0.25 wt. % to 2.5 wt. % in another embodiment 0.25 wt. % to 2 wt %.

In a further embodiment of the present invention, the pesticide is in the range of from 0.25 wt. % to 5 wt. %, in another embodiment from 0.25 wt. % to 4.5 wt. %, in another embodiment, 0.25 wt. % to 4 wt. %, in further embodiment 0.25 wt. % to 3.5 wt. %, in yet another embodiment 0.25 wt. % to 3 wt. %, in a further embodiment 0.25 wt. % to 2.5 wt. % in another embodiment, 0.25 wt. % to 2 wt. %.

In an embodiment of the present invention, the adjuvants are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

In an embodiment of the present invention, the suitable solvents and liquid carriers are organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzyl alcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

In an embodiment of the present invention, the suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

In an embodiment of the present invention, the suitable surfactants are surface-active compounds, such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

In an embodiment of the present invention, the suitable anionic surfactants are alkali, alkaline earth or ammonium salts of sulfonates, sulphates, phosphates, carboxylates, and mixtures thereof. Examples of sulfonates are alkylaryl sulfonates, diphenyl sulfonates, alpha-olefin sulfonates, lignin sulfonates, sulfonates of fatty ac-ids and oils, sulfonates of ethoxylated alkyl phenols, sulfonates of alkoxylated aryl phenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulphates are sulphates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkyl phenol ethoxylate.

In an embodiment of the present invention, the suitable non-ionic surfactants are alkoxylates, N-substituted fatty acid amides, amine oxides, esters, sugar-based surfactants, polymeric surfactants, and mixtures thereof. Examples of alkoxylates are compounds such as alcohols, alkyl phenols, amines, amides, aryl phenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo or copolymers of vinylpyrrolidone, vinyl alcohols, or vinyl acetate.

In an embodiment of the present invention, the cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene ox-ide, or of the A-B-C type comprising alkanol, polyethylene oxide and polypropylene oxide. Suitable polyelectrolytes are polyacids or polybases. Examples of polyacids are alkali salts of poly-acrylic acid or polyacid comb polymers. Examples of polybases are polyvinyl amines or polyethylene amines.

In an embodiment of the present invention, the thickeners are polysaccharides (e.g. xanthan gum, carboxymethylcellulose), inorganic clays (organically modified or unmodified), polycarboxylates, and silicates.

In an embodiment of the present invention, the bactericides are bronopol and isothiazolinone derivatives such as alkylisothiazolinones and benzisothiazolinones.

In an embodiment of the present invention, the anti-freezing agents are ethylene glycol, propylene glycol, urea and glycerin.

In an embodiment of the present invention, the anti-foaming agents are silicones, long chain alcohols, and salts of fatty acids.

In an embodiment of the present invention, the colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

In an embodiment of the present invention, the tackifiers or binders are polyvinyl pyrrolidones, polyvinyl acetates, polyvinyl alcohols, polyacrylates, biological or synthetic waxes, and cellulose ethers.

In an embodiment of the present invention the at least one adjuvant is in the range of from 0.25 wt. % to 5 wt. %, based on the total weight of the composition.

In yet another embodiment of the present invention, the at least one adjuvant is in the range of from 0.25 wt. % to 4.5 wt. %, in another embodiment, 0.25 wt. % to 4 wt. %, in further embodiment 0.25 wt. % to 3.5 wt. %, in yet another embodiment 0.25 wt. % to 3 wt. %, in a further embodiment 0.25 wt. % to 2.5 wt. % in another embodiment 0.25 wt. % to 2 wt. %.

In an embodiment of the present invention, the composition comprises herbicides and at least one cationic polymer containing at least one quaternary nitrogen. The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

Depending on the application method in question, the compositions according to the invention can additionally be employed in a further number of crop plants for eliminating undesirable plants. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Brassica juncea, Brassica campestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihotes-culenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

In an embodiment of the present invention, the crops are Arachis hypogaea, Beta vulgaris spec. altissima, Brassica napus var. napus, Brassica oleracea, Brassica juncea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (S. vulgare), Triticale, Triticum aestivum, Triticum durum, Vicia faba, Vitis vinifera and Zea mays.

In an embodiment of the present invention, the compositions according to the invention can also be used in genetically modified plants, e.g. to alter their traits or characteristics. The term “genetically modified plants” is to be understood as plants, which genetic material has been modified by the use of recombinant DNA techniques in a way that under natural circumstances it cannot readily be obtained by cross breeding, mutations, natural recombination, breeding, mutagenesis, or genetic engineering. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or famesylated moieties or PEG moieties.

In an embodiment of the present invention, the plants that have been modified by breeding, mutagenesis or genetic engineering, e.g. have been rendered tolerant to applications of specific classes of herbicides, are particularly useful with the compositions according to the invention. Tolerance to classes of herbicides has been developed such as auxin herbicides such as dicamba or 2,4-D; bleacher herbicides such as hydroxyphenylpyruvate dioxygenase (HPPD) inhibitors or phytoene desaturase (PDS) inhibitors; acetolactate synthase (ALS) inhibitors such as sulfonyl ureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase (PPO) inhibitors; lipid biosynthesis inhibitors such as acetyl CoA carboxylase (ACCase) inhibitors; or oxynil (i. e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Examples of these herbicide resistance technologies are also described in US 2008/0028482, US2009/0029891, WO 2007/143690, WO 2010/080829, U.S. Pat. Nos. 6,307,129, 7,022,896, US 2008/0015110, U.S. Pat. Nos. 7,632,985, 7,105,724, and 7,381,861, each herein incorporated by reference.

In an embodiment of the present invention, the several cultivated plants have been rendered tolerant to herbicides by conventional methods of breeding (mutagenesis), e.g. Clearfield® summer rape (Canola, BASF SE, Germany) being tolerant to imidazolinones, e.g. imazamox, or ExpressSun® sunflowers (DuPont, USA) being tolerant to sulfonyl ureas, e.g. tribenuron. Genetic engineering methods have been used to render cultivated plants such as soybean, cotton, corn, beets and rape, tolerant to herbicides such as glyphosate, dicamba, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

In an embodiment of the present invention, the plants that are cultivated by the use of recombinant DNA techniques capable to synthesize one or more insecticidal proteins, especially those known from the bacterial genus Bacillus, particularly from Bacillus thuringiensis, such as ä-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e. g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be under-stood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are dis-closed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, Knock-Out®, BiteGard®, Protecta®, Bt11 (e.g. Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

In an embodiment of the present invention, the plants are also covered that are capable to synthesize one or more proteins to increase the resistance or tolerance of those plants to bacterial, viral or fungal pathogens by the use of recombinant DNA techniques. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

In an embodiment of the present invention those plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environ-mental factors or tolerance to pests and fungal, bacterial or viral pathogens of those plants.

In a further embodiment of the present invention, those plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada). Those plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

In a further embodiment of the present invention, the compositions according to the invention are applied to the plants mainly by spraying on the leaves. Here, the application can be carried out using, for example, water as carrier by customary spraying techniques using spray liquor amounts of from about 100 to 1000 l/ha (for example from 300 to 400 l/ha). The herbicidal compositions may also be applied by the low-volume or the ultra-low-volume method, or in the form of microgranules.

In yet another embodiment, the herbicidal compositions according to the present invention can be applied pre- or post-emergence, or together with the seed of a crop plant. It is also possible to apply the compounds and compositions by applying seed, pre-treated with a composition of the invention, of a crop plant.

In yet another embodiment of the present invention, the rates of application of the pesticide are from 0.0001 to 3.0, preferably 0.01 to 1.0 kg/ha of pesticide, depending on the control target, the season, the target plants and the growth stage. To treat the seed, the herbicides are generally employed in amounts of from 0.001 to 10 kg per 100 kg of seed.

### Spray Drift Performance:

In an embodiment of the present invention, the composition is typically applied through a spray nozzle onto a target, such as a plant. The composition is typically atomized under pressure by various engineered nozzles to form spray droplets. In various embodiments, the percentage of droplets having a diameter less than, for example, 105 to 250 microns, are described as “fines”. The optimum droplet size tends to depend on the application. If droplets are too large, there will be less coverage by the spray. The maximum acceptable droplet size may depend on the amount of the concentrate or composition being applied per unit area and the mode of action of the pesticide active ingredient. Smaller droplets provide more even coverage but are more prone to drift during spraying. If it is windy during spraying, larger droplets may be preferred, whereas on a calmer day smaller droplet may be preferred. In addition, spray droplet size may also depend on the spray apparatus; e.g. spray nozzle size and type, height from target, and configuration.

In an embodiment of the present invention, the compositions of the disclosure show a reduced volume percent of droplets having a diameter less than 105, 110, 115, 120, 125, 130, 135, 140, 145, 150, 155 or 160 microns, as determined using ASTM E2798-11 and a Malvern Spray Tech droplet analyser. In other embodiments, less than 70, 65, 60, 55, 50, 45, 40, 35, 30, 25, 20, 15, 10, 5, 4, 3, 2, or 1, percent of the droplets have a diameter of less than 105, 110, 115, 120, 125, 130, 135, 140, 145, 150, 155, or 160, microns, upon spraying, as determined using ASTM E2798-11 and a Malvern Spray Tech droplet analyser. In various embodiments, the compositions of the disclosure show an average fines reduction of 99, 90, 80, 70, 60, 5040, 30, or 20 percent, as determined using ASTM E2798-11 and a Malvern Spray Tech droplet analyser and, for example, a nozzle such as a TeeJet 8002VS nozzle. In other words, in various embodiments, a small percentage of the droplets have small diameters, which is typically desirable because this results in less spray drift. In various non-limiting embodiments, all values and ranges of values between and including the aforementioned values are hereby expressly contemplated.

In another embodiment of the present invention, the aqueous agricultural composition produces fines % V<105 μm of less than 25, upon spraying, as determined using ASTM E2798-11 and a Malvern Spray Tech droplet analyser and a TeeJet 8002VS nozzle. In another embodiment, the aqueous agricultural composition produces fines % V<105 μm of less than 20, upon spraying, as determined using ASTM E2798-11 and a Malvern Spray Tech droplet analyser and a TeeJet 8002VS nozzle.

In an embodiment of the present invention, the composition exhibits shear stability. Shear stability indicates that the composition does not undergo significant change in the viscosity when subjected to repeated shear forces. In the present case, the shear forces are applied when the composition passes through the spray pump.

The present invention offers various advantages: it reduced spray drift fines and off-target movement of pesticide applications compared to current available formulations, while maintaining use friendly handling and use characteristics, and without adversely affecting their pesticidal activity. The compositions reduced driftable fines at a lower adjuvant use rate in the spray tank in comparison to commercial standard applied as a tank mix. Further advantages of the invention are good adhesion of the pesticide on the surface of the treated plants, increased permeation of the pesticides into the plant and, as a result, more rapid and enhanced activity.

### Methods

In an embodiment of the present invention, the method of forming the composition is described herein. The method includes the step of combining the pesticide, the water, and the at least one cationic polymer. This step may also include adding any additives described above. The aforementioned components and compounds may be added in any order to one or more of each other and in any amount and in one or more individual steps, e.g. in whole or in parts.

In an embodiment of the present invention, a method of forming the concentrate is described herein. The method may include the step of combining the at least one cationic polymer and one or more optional additives. Alternatively, the method may include the step of combining the pesticide, the at least one cationic polymer, and one or more optional additives. Further, the method may include the step of combining the pesticide and the co-polymer. The aforementioned components and compounds may be added in any order to one or more of each other and in any amount and in one or more individual steps, e.g. in whole or in parts

In an embodiment of the present invention, a method of applying the composition to an agricultural target wherein the method includes the step of spraying the composition. The agricultural target may be any known in the art of pesticide applications and may be, for examples, weeds, crops, fields, plants, etc. In one embodiment, the agricultural target is a weed. In another embodiment, the agricultural target is a crop. In a further embodiment, the agricultural target is a field. In another embodiment, the agricultural target is a plant. In a further embodiment, the agricultural target is turf. In yet another embodiment, the agricultural target is a horticultural target. Moreover, the agricultural target may be grass or a field or a pasture. The agricultural target may be associated with a residential or commercial application.

In an embodiment of the present invention, the method of applying the composition comprises spraying the aqueous composition onto a tract of land either prior to planting an agricultural crop or pre- or post-harvest of an agricultural crop.

Moreover, the step of spraying may utilize a spray nozzle and may be further defined to include any parameters known in the art of spraying pesticides. The spray nozzle may be any known in the art such as a TeeJet® 8002VS, TTI11004-VP TeeJet® Spray Tip Nozzle or any other suitable nozzle as would be recognized by one of skill in the art.

The composition of the present invention offers one or more of following advantages:
2. Reduced spray drift fines and off-target movement of pesticide applications compared to current available formulations, while maintaining user friendly handling and use characteristics, and without adversely affecting their pesticidal activity.
3. The composition exhibits shear stability.

### EMBODIMENTS

1. A composition for spray drift control comprising
   (i) at least one cationic polymer containing at least one quaternary nitrogen atom; and
   (ii) at least one agriculturally active compound.
2. The composition according to embodiment 1, wherein (i) the at least one cationic polymer containing at least one quaternary nitrogen atom is a reaction product of:
   (A) at least one ethylenically unsaturated, quaternizable or quaternized monomer; and
   (B) optionally at least one ethylenically unsaturated, non-quaternizable monomer.
3. The composition according to embodiment 2, wherein (A) the at least one ethylenically unsaturated, quaternizable or quaternized monomer is selected from N-vinyl imidazole, diallylamines, aminoalkylmethacrylate, aminoalkylacrylate N,N,N-trialkyl aminoalkyl acrylates, N,N,N-trialkyl aminoalkyl methacrylate, and mixtures thereof.
4. The composition according to embodiment 2 or 3, wherein (A) the at least one ethylenically unsaturated, quaternizable or quaternized monomer is selected from N-vinyl imidazolium chloride, 3-methyl vinyl-imidazolium methyl sulfate, 3-methyl vinyl-imidazolium chloride, N,N-diallyl N,N-dimethyl ammonium chloride dimethylaminoethyl methacrylate, 2-methylacryloxyethyltrimethyl ammonium chloride, and mixtures thereof.
5. The composition according to embodiment 2, wherein (B) the at least one ethylenically unsaturated, non-quaternizable, monomer is selected from N-vinyl lactams, ethylenically unsaturated amides, and mixtures thereof.
6. The composition according to embodiment 5, wherein the N-vinyl lactams are selected from N-vinyl pyrrolidone, N-vinyl piperidone and N-vinyl caprolactam.
7. The composition according to embodiment 5, wherein the ethylenically unsaturated amides are selected from acrylamide and methacrylamide.
8. The composition according to any one of embodiments 2 to 4, wherein (A) the amount of the at least one ethylenically unsaturated, quaternizable or quaternized monomer is in the range of from 1 wt. % to 100 wt. %, based on the weight of the at least one polymer.
9. The composition according to any one of embodiments 2 or 5 to 7, wherein (B) the amount of the at least one non-quaternizable, ethylenically unsaturated monomer is in the range of from 0 wt. % to 99 wt. %, based on the weight of the at least one polymer.
10. The composition according to any one of embodiments 1 to 9, wherein (i) the at least one cationic polymer containing at least one quaternary nitrogen atom is a reaction product of N-vinyl pyrrolidone and dimethyl aminoethyl methacrylate.
11. The composition according to any one of embodiments 1 to 9, wherein (i) the at least one cationic polymer containing at least one quaternary nitrogen atom is a reaction product of N,N-diallyl N,N-dimethyl ammonium chloride and acrylamide.
12. The composition according to any one of embodiments 1 to 9, wherein (i) the at least one cationic polymer containing at least one quaternary nitrogen atom is a reaction product of N-vinyl pyrrolidone and N-vinyl imidazolium chloride.
13. The composition according to any one of embodiments 1 to 9, wherein (i) the at least one cationic polymer containing at least one quaternary nitrogen atom is a reaction product of N-vinyl caprolactam, N-vinyl pyrrolidone and 3-methyl N-vinyl imidazolium methylsulfate.
14. The composition according to any one of embodiments 1 to 9, wherein (i) the at least one cationic polymer containing at least one quaternary nitrogen atom is a reaction product of 2-methacryloxyethyl trimethyl ammonium chloride.
15. The composition according to any one of embodiments 1 to 14, wherein the charge density of (i) the at least one cationic polymer containing at least one quaternary nitrogen atom is in the range of 0.5 to 10 meq/g, determined at pH 7.
16. The composition according to any one of embodiments 1 to 15, wherein the molecular weight of (i) the at least one cationic polymer containing at least one quaternary nitrogen atom is in the range of from 100,000 to 3,000,000 g/mol, as determined according to gel permeation chromatography.
17. The composition according to embodiment 1, wherein (ii) the at least one agriculturally active compound is a pesticide selected from the group of herbicide, insecticide and fungicide.
18. The composition according to embodiment 17, wherein the pesticide is an herbicide.
19. The composition according to embodiment 18, wherein the herbicide is selected from the class of acetamides, amino acid derivatives, aryloxyphenoxypropionates, bipyridyls, (thio)carbamates, cyclohexanediones, dinitroanilines, diphenyl ethers, hydroxybenzonitriles, imidazolinones, phenoxy acetic acids, pyrazines, pyridines, sulfonylureas, triazines, ureas, and acetolactate synthase inhibitors.
20. The composition according to embodiment 17, wherein the pesticide is an insecticide.
21. The composition according to embodiment 20, wherein the insecticide is selected from the class of organo (thio)phosphates, carbamates, pyrethroids, insect growth regulators, nicotinic receptor agonists/antagonists, macrocyclic lactones, mitochondrial electron transport inhibitors, oxidative phosphorylation inhibitors, moulting disruptor compounds and mixed function oxidase inhibitors.
22. The composition according to embodiment 17, wherein the pesticide is a fungicide.
23. The composition according to embodiment 22, wherein the fungicide is selected from the class of respiration inhibitors, sterol biosynthesis inhibitors, nucleic acid synthesis inhibitors, inhibitors of cell division and cytoskeleton, inhibitors of amino acid and protein synthesis, signal transduction inhibitors, protein inhibitors, lipid and membrane synthesis inhibitors, inhibitors with multi-site action, cell wall synthesis inhibitors and plant defence inducers.
24. The composition according to any of embodiments 1 to 23, wherein the composition is in the form of dusting powders, wettable powders, granules, emulsifiable or suspension concentrates, aqueous compositions and microencapsulated granules.
25. An aqueous composition comprising water and the composition according to any one of embodiments 1 to 24.
26. The aqueous composition according to embodiment 25, wherein the amount of (i) the at least one cationic polymer containing at least one quaternary nitrogen atom is in the range of from 0.003 vol. % to 1 vol. %, based on the total volume of the aqueous composition.
27. The aqueous composition according to embodiment 26, wherein the amount of (i) the at least one cationic polymer containing at least one quaternary nitrogen atom is in the range of from 0.03 vol. % to 0.5 vol. %, based on the total weight of the aqueous composition.
28. The aqueous composition according to any one of embodiments 25 to 27, wherein (ii) the amount of the at least one agriculturally active compound is in the range of from 0.01 wt. % to 5 wt %, based on the total weight of the aqueous composition.
29. The aqueous composition according to any one of embodiments 25 to 27, wherein the amount of water is in the range of from 1 wt. % to 99 wt. %, based on the total weight of the aqueous composition.
30. The aqueous composition according to embodiments 25 to 29, wherein the aqueous composition has a pH value in the range of from 4 to 9.
31. The composition according to any one of embodiments 25 to 30, further comprising at least one adjuvant.
32. The composition according to embodiment 31, wherein the at least one adjuvant is selected from surfactants, dispersants, emulsifiers, wetters, solubilizers, penetration enhancers, adhesion agents, thickeners, humectants, anti-freezing agents, anti-foaming agents, colorants, tackifiers, and mixtures thereof.
33. The composition according to embodiments 25 to 32, wherein the amount of the at least one adjuvant is in the range of from 0.25 wt. % to 5 wt. %, based on the total weight of the composition.
34. A method for reducing spray drift, the method comprising spraying the aqueous composition according to any one of embodiments 25 to 33 onto a tract of land either prior to planting an agricultural crop or pre- or post-harvest of an agricultural crop.
35. Use of the aqueous composition according to any one of embodiments 25 to 33 for controlling spray drift.
36. Kit of parts comprising, as separate components, (i) at least one cationic polymer containing at least one quaternary nitrogen atom as defined in any one of embodiments 1 to 24 for a combined use; and b) the at least one agriculturally active compound as defined according to any of embodiments 1 to 24.

### EXAMPLES

The presently claimed invention is illustrated in detail by non-restrictive working examples which follow. More particularly, the test methods specified hereinafter are part of the general disclosure of the application and are not restricted to the specific working examples.

### Compounds

Pesticide
Glyphosate (N-(phosphonomethyl)glycine)) is a broad-spectrum systemic herbicide.
Headline® (pyroclostrobin (methyl (2-(((1-(4-chlorophenyl)-1H-pyrazol-3-yl)oxy)methyl)phenyl)(methoxy)carbamate) is a fungicide.
Remedy® Ultra (triclopyr (2-[(3,5,6-trichloro-2-pyridinyl)oxy] acetic acid)) is a herbicide.

### Cationic Polymers

Polyquaternium 11 (Copolymer of vinylpyrrolidone and quaternized dimethylaminoethyl methacrylate) having a charge density of 0.8 meq/g determined at a pH of 7
Polyquaternium 7 (Diallyl dimethyl ammonium chloride/Acrylamide Co-polymer having a charge density of 1.6 meq/g determined at a pH of 7.
Polyquaternium 37, (poly 2-methacryloxyethyl trimethyl ammonium chloride) having a charge density of 2-7 meq/g determined at a pH of 7.
Polyquaternium 16 (vinylpyrrolidone/vinylimidazolium chloride copolymer) having a charge density of 3 meq/g determined at a pH of 7.
Polyquaternium 46 (polymeric quaternary ammonium salt prepared by the reaction of vinylcaprolactam and vinylpyrrolidone with methylvinylimidazolium methosulfate) having a charge density of 0.5 meq/g determined at a pH of 7.

### Measurement of % Volume of Droplet (% V<105 μm)

The percentage volume of droplets with a droplet size of less than 105 μm was determined by the method outlined in the ‘U.S. EPA Generic Verification Protocol for Testing Pesticide Application Spray Drift Reduction Technologies for Row and Field Crops as set forth in the June 2016 Final Generic Verification Protocol for Pesticide Spray DRT.

### Spray Drift Measurement

The compositions were formulated as indicated in tables 1 to 5. The percent volume of droplets for the entire spray pattern were measured for each of the water/pesticide solutions mixed at labelled concentrations as directed by the pesticide formulator. The example polymers were added to the pesticide/water spray solutions and the new resulting percent volumes for the total spray pattern were measured. The ratio of the percent volume of droplets less than 105 μm for pesticide spray solutions with and without the example polymers was used to demonstrate reduction of driftable drops.

For example, tap water with glyphosate ratio=% V<105 μm of (tap water+glyphosate+additive)/% V<105 μm of tap water+glyphosate.

TABLE 1

| | Control | Example 1 | Example 2 | Example 3 | Example 4 |
|---|---|---|---|---|---|
| Tap Water | 100% | 99% | 97.3% | 97.8% | 98% |
| Polyquaternium 7 | | 1% | 1% | 1% | 1% |
| Glyphosate | — | — | 1.7% | — | — |
| Headline ® | — | — | — | 1.2% | — |
| Remedy ® ultra | — | — | — | — | 1% |
| %V <105 μm | 19.4 | 11.1 | 13.36 | 12.02 | 17.64 |

TABLE 2

| | Control | Example 5 | Example 6 | Example 7 |
|---|---|---|---|---|
| Tap Water | 100% | 99% | 97.3% | 98% |
| Polyquaternium 11 | — | 1% | 1% | 1% |
| Glyphosate | — | — | 1.7% | — |
| Remedy ® Ultra | — | — | — | 1% |
| %V <105 μm | 19.9 | 10.9 | 10.54 | 12.73 |

TABLE 3

| | Control | Example 8 | Example 9 | Example 10 |
|---|---|---|---|---|
| Tap Water | 100% | 99% | 97.3% | 98% |
| Polyquaternium 16 | — | 1% | 1% | 1% |
| Glyphosate | — | — | 1.7% | — |
| Remedy ® Ultra | — | — | — | 1% |
| %V <105 μm | 19.5 | 15.3 | 17.55 | 15.6 |

TABLE 4

| | Control | Example 11 | Example 12 |
|---|---|---|---|
| Tap Water | 100% | 99% | 97.3% |
| Polyquaternium 37 | — | 1% | 1% |
| Glyphosate | — | — | 1.7% |
| %V <105 μm | 19.0 | 13.4 | 13.49 |

TABLE 5

| | Control | Example 13 | Example 14 |
|---|---|---|---|
| Tap Water | 100% | 99% | 97.3% |
| Polyquaternium 46 | — | 1% | 1% |
| Glyphosate | — | — | 1.7% |
| %V <105 μm | 19.8 | 17.4 | 17.4 |

As shown in the tables 1-5 above, the % V of droplets with a size of less than 105 μm decreases when the cationic polymers are added to the aqueous pesticidal formulations (examples 2-4, 6.7, 9, 10, 12 and 14). The lower number of % V of droplets with a size of less than 105 μm is desirable as it leads to lower spray drift and hence the pesticide formulation will not drift away from the target crops.

A lower amount of % V<105 result in the calculation of a smaller (untreated) buffer zone for the farm growers at the time of application.

### Shear Stability

The cationic polymer, polyquaternium 7 was studied for shear stability. The results are indicated in table 6. To conduct this study, a 18 liter sample of 1.0%-v/v Polyquaternium 7+1.7%-v/v Glyphosate solution (aq) was prepared. Three liters of sample were collected and measured for droplet size sprayed through a TTI 11004 Teejet Nozzle (@63.5 psi) at the following times: Before pumping (Zero Passes), after 1 pass, after the 3^{rd} pass, after the 5^{th} pass, after the 7^{th} pass and after the 10^{th} pass. With each additional pass, the formulation is exposed to a greater shear force.

TABLE 6

| | | % | |
|---|---|---|---|
| | No. of | driftable | % |
| | passes | fines | Reduction |
| 1.0%-v/v of Polyquaternium 7 + | Zero Pass | 1.20 | 48.0 |
| 1.7% Glyphosate solution | 1st Pass | 1.26 | 45.3 |
| | 3rd Pass | 1.80 | 21.6 |
| | 5th Pass | 1.81 | 21.3 |
| | 7th Pass | 2.10 | 8.4 |
| | 10th Pass | 2.30 | 0.0 |
| 1.7% Glyphosate + 98.3% water | Water/Pmax | 2.30 | — |
| Water | Water | 3.52 | — |

The 1.0%-v/v of Polyquaternium 7+1.7%-v/v Glyphosate solution exhibited good stability after undergoing several passes through the pump since no significant difference was observed in the percentage of driftable fines until the seventh pass.

From the above table, it is evident that the aqueous pesticidal solution comprising the cationic polymer was shear stable.

Thus, the cationic polymers are not only performing as drift reduction agents, but also stabilize the drift reduction performance of the formulation from the affects of shear from the pump.

1. A composition for spray drift control comprising
(i) a cationic polymer containing at least one quaternary nitrogen atom which is a reaction product of:
(A) at least one ethylenically unsaturated, quaternizable or quaternized monomer selected from the group consisting of N-vinyl imidazole, diallylamines, aminoalkylmethacrylate, aminoalkylacrylate, N,N,N-trialkyl aminoalkyl acrylates, N,N,N-trialkyl aminoalkyl methacrylate, and mixtures thereof; and
(B) optionally at least one ethylenically unsaturated, non-quaternizable monomer selected from the group consisting of N-vinyl lactams, ethylenically unsaturated amides, and mixtures thereof; and
(ii) at least one agriculturally active compound.

2. The composition according to claim 1, wherein the at least one ethylenically unsaturated, quaternizable or quaternized monomer (A) is selected from the group consisting of N-vinyl imidazolium chloride, 3-methyl vinyl-imidazolium methyl sulfate, 3-methyl vinyl-imidazolium chloride, N,N-diallyl N,N-dimethyl ammonium chloride dimethylaminoethyl methacrylate, 2-methylacryloxyethyltrimethyl ammonium chloride, and mixtures thereof.

3. The composition according to claim 1, wherein the N-vinyl lactams are selected from the group consisting of N-vinyl pyrrolidone, N-vinyl piperidone and N-vinyl caprolactam.

4. The composition according to claim 1, wherein the ethylenically unsaturated amides are selected from the group consisting of acrylamide and methacrylamide.

5. The composition according to claim 1, wherein the at least one cationic polymer containing at least one quaternary nitrogen atom (i) is a reaction product of N-vinyl pyrrolidone and dimethyl aminoethyl methacrylate.

6. The composition according to claim 1, wherein the at least one cationic polymer containing at least one quaternary nitrogen atom (i) is a reaction product of N,N-diallyl N,N-dimethyl ammonium chloride and acrylamide.

7. The composition according to claim 1, wherein the at least one cationic polymer containing at least one quaternary nitrogen atom (i) is a reaction product of N-vinyl pyrrolidone and N-vinyl imidazolium chloride.

8. The composition according to claim 1, wherein the at least one cationic polymer containing at least one quaternary nitrogen atom (i) is a reaction product of N-vinyl caprolactam, N-vinyl pyrrolidone and 3-methyl N-vinyl imidazolium methyl sulfate.

9. The composition according to claim 1, wherein the at least one cationic polymer containing at least one quaternary nitrogen atom (i) is a reaction product of 2-methacryloxyethyl trimethyl ammonium chloride.

10. The composition according to claim 1, wherein the charge density of the at least one cationic polymer containing at least one quaternary nitrogen atom (i) is in the range of 0.5 to 10 meq/g, determined at pH 7.

11. The composition according to claim 1, wherein the at least one agriculturally active compound (ii) is a pesticide selected from the group consisting of herbicide, insecticide and fungicide.

12. The composition according to claim 1 wherein the composition is in the form of dusting powders, wettable powders, granules, emulsifiable or suspension concentrates, aqueous compositions and microencapsulated granules.

13. An aqueous composition comprising water and the composition according to claim 1, wherein the aqueous composition has a pH value in the range of from 4 to 9.

14. The aqueous composition according to claim 13, wherein the amount of the at least one cationic polymer containing at least one quaternary nitrogen atom (i) is in the range of from 0.003 vol. % to 1 vol. %, based on the total volume of the aqueous composition.

15. The aqueous composition according to claim 13, wherein the amount of the at least one agriculturally active compound (ii) is in the range of from 0.01 wt. % to 5 wt. %, based on the total weight of the aqueous composition.

16. The aqueous composition according to claim 13, further comprising at least one adjuvant.

17. The aqueous composition according to claim 16, wherein the at least one adjuvant is selected from the group consisting of surfactants, dispersants, emulsifiers, wetters, solubilizers, penetration enhancers, adhesion agents, thickeners, humectants, anti-freezing agents, anti-foaming agents, colorants, tackifiers, and mixtures thereof.

18. The aqueous composition according to claim 16, wherein the amount of the at least one adjuvant is in the range of from 0.25 wt. % to 5 wt. %, based on the total weight of the composition.

19. A method for reducing spray drift, the method comprising spraying the aqueous composition according to claim 13 onto a tract of land either prior to planting an agricultural crop or pre- or post-harvest of an agricultural crop.

20. A method of using the aqueous composition according to claim 13 for controlling spray drift.

21. A kit of parts comprising, as separate components,
(i) at least one cationic polymer containing at least one quaternary nitrogen atom which is a reaction product of:
(A) at least one ethylenically unsaturated, quaternizable or quaternized monomer selected from the group consisting of N-vinyl imidazole, diallylamines, aminoalkylmethacrylate, aminoalkylacrylate, N,N,N-trialkyl aminoalkyl acrylates, N,N,N-trialkyl aminoalkyl methacrylate, and mixtures thereof; and
(B) optionally at least one ethylenically unsaturated, non-quaternizable monomer selected from the group consisting of N-vinyl lactams, ethylenically unsaturated amides, and mixtures thereof, for a combined use; and ii) at least one agriculturally active compound.
